(19) United States
(12) Patent Application Publication
(10) Pub. No.: US 2009/0042609 A1
(43) Pub. Date: Feb. 12, 2009

(54) Selective Rendering of Multimedia Information

(75) Inventor: Leland Scott Bloebaum, Cary, NC (US)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 12/251,551

(22) Filed: Oct. 15, 2008

Related U.S. Application Data
(63) Continuation-in-part of application No. 11/477,580, filed on Jun. 29, 2006.

(51) Int. Cl. H04M 1/00

(52) U.S. Cl. 455/556.1

(57) ABSTRACT

A method and apparatus for selectively rendering audio-video information to user output devices based on the current configuration of the wireless communication device is described herein. The audio-video information comprises an audio component, a video component, and a metadata component. The wireless communication device outputs the video component to an internal display and the audio component to a speaker when the wireless communication device operates in an open configuration. When in the closed configuration, the wireless communication device stops outputting the video component to the internal display. Further, the closed wireless communication device continues to output the audio component to the speaker while outputting the metadata to an external display.

### BACKGROUND

This application is a continuation-in-part of co-pending U.S. application Ser. No. 11/477,580 filed 29 Jun. 2006, and titled “Method and Apparatus for Displaying User Information on an External Display,” which is incorporated herein by reference in its entirety.

### BACKGROUND

The present invention relates generally to wireless communication devices, and more particularly to rendering audio-video signals on user interface elements of wireless communication devices.

In recent years, mobile telephones have evolved from telephone devices used primarily for voice communications into multi-media communication devices capable of both voice and data communications. Consumers now use wireless communication devices to surf the web, send and receive e-mail messages, chat with friends, view images, play music and/or video data, and perform other tasks that previously required a personal computer.

The clamshell is currently the most popular type of housing for wireless communication devices because it enables the wireless communication device to assume a compact shape when closed while still providing acceptably large displays and user input devices when open. However, clamshells still have some disadvantages. For example, a closed clamshell typically covers an internal display, which limits the information a user may receive while the device is closed. While newer clamshell devices often include an external display, overall cost and device size limitations typically require such external displays to have smaller sizes and resolution than their internal counterparts. External displays therefore limit the amount of displayed data available from a closed clamshell to the user.

### SUMMARY

The present invention selectively delivers audio-video information to user output devices, e.g., audio and video output devices, based on the current configuration of the wireless communication device. For example, the wireless communication device may output audio-video information by outputting the video component to an internal display and the audio component to a speaker when the wireless communication device operates in an open configuration. When the wireless communication device operates in the closed configuration, the wireless communication device stops outputting the video component to the internal display. Further, the closed wireless communication device continues to output the audio component to the speaker while outputting metadata associated with the audio-video information to an external display.

Exemplary embodiments of the present invention comprise a wireless communication devices comprising an audio output device, first and second display areas, and an audio-video processor operatively connected to said audio output device and said first and second display areas. The audio-video processor is configured to output an audio component of an audio-video signal to the audio output device when the wireless communication device operates in an open configuration and a closed configuration; output a video component of the audio-video signal to the first display area when a current configuration of the wireless communication device comprises the open configuration; and output metadata associated with the audio-video signal to the second display area and discontinue the video component output to the first display area when the current configuration of the wireless communication device comprises the closed configuration.

In one exemplary wireless communication device, the first and second display areas comprise separate first and second displays, wherein the first display comprises an internal display visible when said wireless communication device operates in said open configuration and concealed when said wireless communication device operates in said closed configuration, and wherein the second display comprises an external display visible when said wireless communication device operates in said closed configuration.

In one exemplary wireless communication device, the first and second display areas are part of one display, wherein the first display area comprises the portion of the display visible when said wireless communication device operates in said open configuration, and wherein the second display area comprises the portion of the display visible when said wireless communication device operates in said closed configuration.

In one exemplary wireless communication device, the audio output device comprises at least one of a speaker and an audio output port.

In one exemplary wireless communication device, the audio-video processor is further configured to put the first display area in a sleep mode or power down the first display area when the wireless communication device operates in the closed configuration.

The exemplary wireless communication device may further comprise a sensor configured to detect the current configuration of the wireless communication device.

Exemplary embodiments of the present invention also include a method of rendering audio-video signals on user interface elements of a wireless communication device. One exemplary method comprises outputting an audio component of the audio-video signals to an audio output device when the wireless communication device operates in an open configuration and in a closed configuration; outputting a video component of the audio-video signal to a first display area when a current configuration of the wireless communication device comprises the open configuration; and outputting metadata associated with the audio-video signal to a second display area and discontinuing the video component output to the first display area when a current configuration of the wireless communication device comprise the closed configuration.

In one exemplary method, the first and second display areas comprise separate first and second displays, wherein the first display comprises an internal display visible when said wireless communication device operates in said open configuration and concealed when said wireless communication device operates in said closed configuration, and wherein the second display comprises an external display visible when said wireless communication device operates in said closed configuration.

In one exemplary method, the first and second display areas are part of one display, wherein the first display area comprises the portion of the display visible when said wireless communication device operates in said open configuration, and wherein the second display area comprises the portion of the display visible when said wireless communication device operates in said closed configuration.

In one exemplary method, outputting the audio component comprises outputting the audio component to at least one of a speaker and an audio output port when the wireless communication device operates in the open configuration and the closed configuration.

The exemplary method may further comprise putting the first display area in a sleep mode or powering down the first display area when the wireless communication device operates in the closed configuration.

The exemplary method may further comprise detecting the current configuration of the wireless communication device.

### BRIEF DESCRIPTION OF THE DRAWINGS

FIGS. 1A and 1B show one exemplary wireless communication device according to the present invention.

FIG. 2 shows a block diagram for an exemplary wireless communication device.

FIG. 3 shows an exemplary audio-video output control process.

FIGS. 4A and 4B show another exemplary wireless communication device according to the present invention.

FIGS. 5A and 5B show another exemplary wireless communication device according to the present invention.

### DETAILED DESCRIPTION

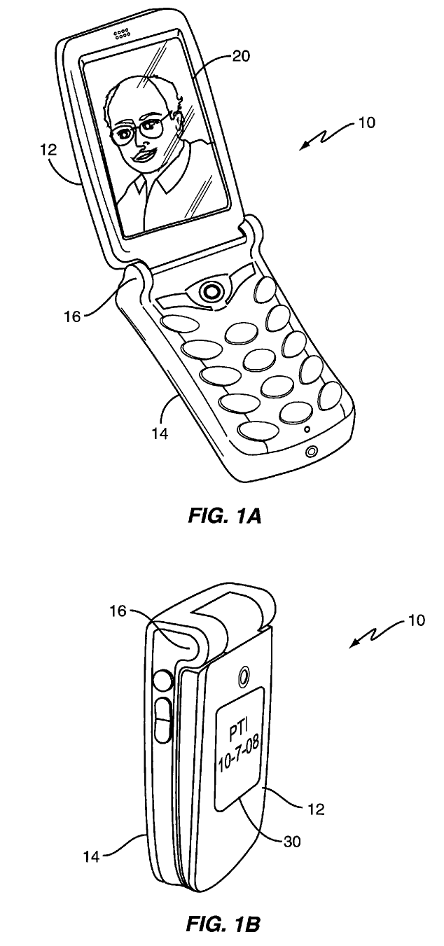

FIGS. 1A and 1B show one exemplary wireless communication device 10 according to the present invention. Wireless communication device 10 comprises a clamshell housing with a first housing section 12 connected to a second housing section 14 by a jointed connector 16, such as a hinge. As shown in FIG. 1A, a first display 20 comprises a large internal display that is visible when the wireless communication device 10 is in an open configuration, e.g., the first and second housing sections 12, 14 are spaced apart. Further, a second display 30 comprises a smaller external display that is visible when the wireless communication device 10 is in a closed configuration, e.g., the first and second housing sections 12, 14 are positioned proximate each other, as shown in FIG. 1B.

The external display of a conventional wireless communication device typically provides a limited amount of space for displaying information. Conventionally, the external display displays the current time and limited device operation data. The larger internal display outputs information generated by user applications, such as multi-media applications. However, it is sometimes impractical, inconvenient, or undesirable to open the wireless communication device to view the application data. For example, it may be undesirable to open the wireless communication device to access the audio-video data while driving.

According to the present invention, the wireless communication device 10 outputs an audio component of the audio-video data to an audio output device, such as a speaker, when the wireless communication device 10 is configured in both the open and closed positions. When the wireless communication device 10 is configured in the closed configuration, the wireless communication device 10 stops outputting the video component to the internal display 20, and instead outputs metadata associated with the audio-video data to the external display 30. As used herein, the metadata represents the data that describes the audio-video data, e.g., program title, date, programming channel, etc. For example, the metadata may comprise a still image (e.g., a thumbnail) representing the content of the audio-video signal. Thus, a user may view identification information for the output audio-video data without opening the wireless communication device 10.

The wireless communication device 10 of the present invention provides the user with access to at least some of the desired audio-video information even when the wireless communication device 10 is in the closed configuration. The present invention therefore enables the user to listen to the audio-video data while engaged in some other activity that prevents them from opening the wireless communication device 10 and/or prevents them from watching the audio-video data. Further, the present invention enables the wireless communication device 10 to conserve battery power during audio-video operations by limiting the power applied to the internal display 20.

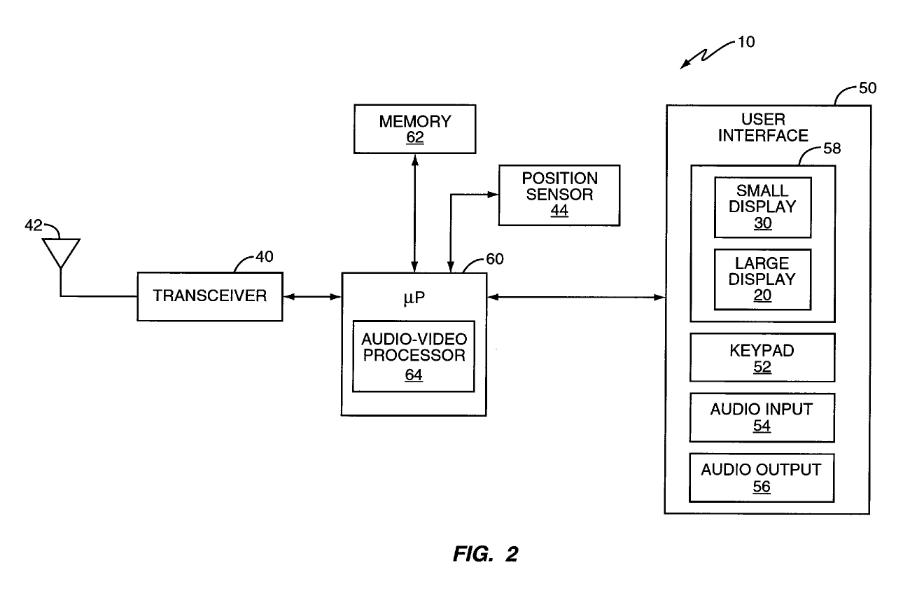

FIG. 2 shows a block diagram of an exemplary wireless communication device 10 used to implement the present invention. Wireless communication device 10 includes a long-range wireless transceiver 40 that transmits signals to and receives signals from one or more base stations via antenna 42. The transceiver 40 may operate according to any known standard. Exemplary communication standards include but are not limited to, Code Division Multiple Access (CDMA), Global System for Mobile Communications (GSM), Universal Mobile Telecommunications System (UMTS), Orthogonal Frequency Division Multiplexing (OFDM), etc. Wireless communication device 10 also includes a position sensor 44, user interface 50, controller 60, and memory 62. Position sensor 44 detects the relative configuration of first and second housing sections 12, 14. User interface 50 enables the user to interact with the wireless communication device 10. The user interface 50 includes one or more keypad controls 52, an audio input device 54 (e.g., a microphone), an audio output device 56 (e.g., a speaker or audio output port), and a video output system 58, which includes the internal display 20 and external display 30 discussed above. Controller 60 performs various processing tasks, including control of the overall operation of wireless communication device 10, according to programs stored in memory 62, which stores data and programs needed for operation.

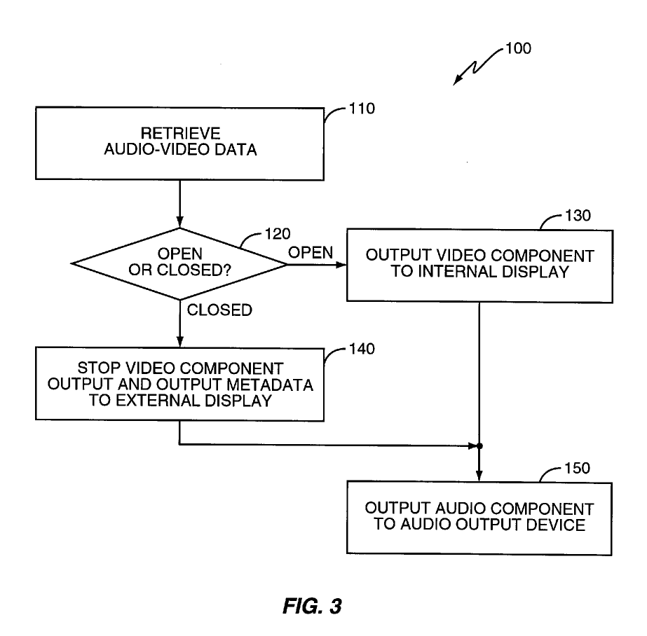

Controller 60 includes an audio-video processor 64 that implements the exemplary process 100 shown in FIG. 3 to control the output of the audio-video information to the user interface 50 based on the configuration of the wireless communication device 10. The audio-video processor 64 retrieves audio-video data responsive to user input (step 110). The retrieved audio-video data comprises an audio component, a video component, and metadata about the audio and/or video components. Processor 64 may retrieve the audio-video data from memory 62. Alternatively, audio-video processor 64 may download audio-video data received by transceiver 40 from a remote source. The audio-video processor 64 also determines whether the wireless communication device 10 is in an open or closed configuration based on the signal provided by position sensor 44 (step 120). This determination may be made when playback of the audio-video file begins, and/or during playback (e.g., after playback begins). When the wireless communication device 10 is in an open configuration, the audio-video processor 64 outputs the video component to the internal display 20 (block 130) and outputs the audio component to the audio output device 56 (block 150). When the wireless communication device 10 is in a closed configuration, the audio-video processor 64 continues to output the audio component to the audio output device 56 (block 150), but stops outputting the video component to the internal display 20, and outputs the metadata to the external display (block 140). As a result, the user may continue to enjoy the audio content identified by the metadata even when the internal display 20 is concealed, i.e., while wireless communication device 10 is closed.

For example, the user may provide input to the user interface 50 that selects a sports program, e.g., ESPN's PTI. In response to the user input, the controller 60 controls the transceiver 40 to download the selected episode of PTI. The audio-video processor 64 outputs the downloaded audio-video data to the user interface 50 based on the current configuration of the wireless communication device 10. If the wireless communication device 10 is in an open configuration, audio-video processor 64 outputs the video component of PTI to the internal display 20 (FIG. 1A) and outputs the audio component of PTI to the audio output device 56. If wireless communication device 10 is in a closed configuration, audio-video processor 64 stops outputting the video component to the internal display 20 and instead outputs the metadata associated with the selected program (e.g., “PTI” and the date of the episode, FIG. 1B), and continues to output the audio component to the audio output device 56.

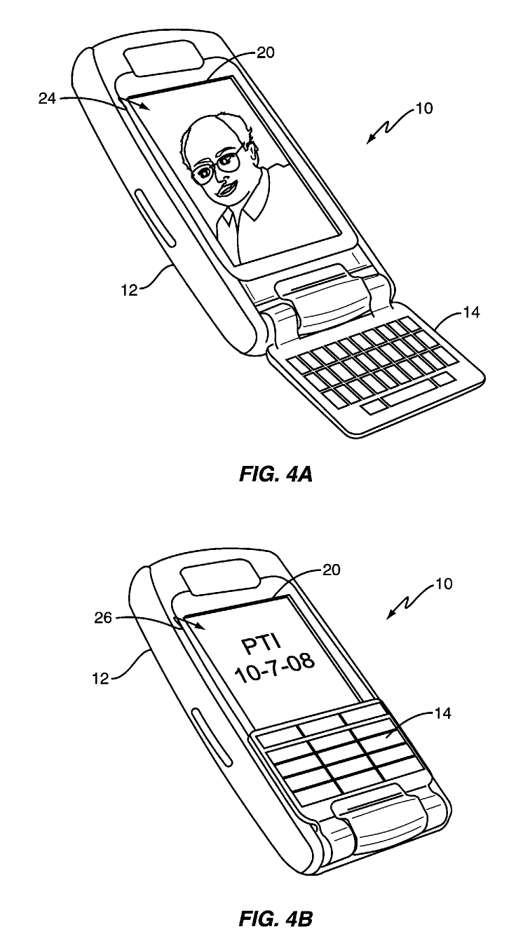

FIGS. 4A and 4B show an alternate wireless communication device 10 comprising a flip device 10. Instead of having two separate displays, flip device 10 comprises one display 20 with multiple display areas. When flip device 10 is in an open configuration, a first display area 24 comprising all of display 20 is visible (FIG. 4A). However, when flip device 10 is in a closed configuration, the second housing section 14 conceals a portion of the display 20 (FIG. 4B). As a result, when flip device 10 is closed, a second display area 26 comprising a portion of display 20 is visible. For this embodiment, audio-video processor 64 outputs the video component to the first display area 24 when the flip device 10 is open. When the flip device 10 is closed, the audio-video processor 64 stops outputting the video component and outputs the metadata to the second display area 26. In both cases, the audio-video processor 64 outputs the audio component to the audio output device 56.

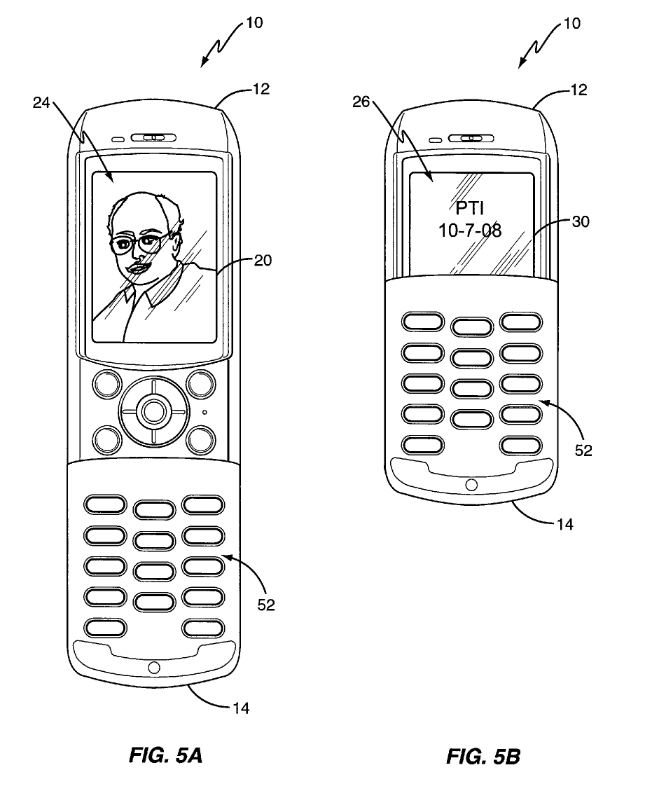

FIGS. 5A and 5B show another alternate wireless communication device 10 comprising a slider device 10 having a display 20. When slider device 10 is in an open configuration, a first display area 24 comprising the entire display 20 is visible (FIG. 5A). When slider device 10 is in a closed configuration (FIG. 5B), the second housing section 14 conceals a portion of display 20, leaving a smaller second display area 26 visible. Audio-video processor 64 outputs the video component to the first display area 24 when the slider device 10 is open. When the slider device 10 is closed, audio-video processor 64 stops outputting the video component and outputs the metadata to the second display area 26. In both cases, the audio-video processor 64 outputs the audio component to the audio output device 56.

The second housing section 14 for both the flip and slider devices of FIGS. 4 and 5 may comprise a solid structure that partially covers the display 20 when closed, as shown in FIGS. 4B and 5B. While not explicitly shown, it will be appreciated that the second housing section 14 may alternatively comprise a solid structure with a transparent window, where the second display area 26 comprises that portion of the display 20 visible through the transparent window when the wireless communication device is in the closed configuration.

While not required, when the wireless communication device 10 is in the closed configuration, controller 60 may control the first display 20 or display area 24 to conserve battery power. For example, the controller 60 may power down all or part of the first display 20 or display area 24. Alternatively, controller 60 may put all or part of the first display 20 or display area 24 in a sleep mode when the wireless communication device 10 is in a closed configuration.

The above-described wireless communication device 10 and audio-video control process has advantages over conventional wireless communication devices having different display areas visible in open and closed configurations. For example, using the invention described above, a user may watch and listen to a selected audio-video program when time and battery power permit. Alternatively, the user may just listen to the selected program if battery power is low or if the user is involved in other activities, e.g., exercise, driving, etc., that prevents the user from viewing the selected program. As such, the present invention provides users with an alternative way to receive selected programming even when the mobile device 10 is in a closed configuration.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A wireless communication device comprising:
an audio output device;
first and second display areas; and
an audio-video processor operatively connected to said audio output device and said first and second display areas, said audio-video processor configured to:
output an audio component of an audio-video signal to the audio output device when the wireless communication device operates in an open configuration and a closed configuration;
output a video component of the audio-video signal to the first display area when a current configuration of the wireless communication device comprises the open configuration; and
output metadata associated with the audio-video signal to the second display area and discontinue the video component output to the first display area when the current configuration of the wireless communication device comprises the closed configuration.

2. The wireless communication device of claim 1 wherein the first and second display areas comprise separate first and second displays, wherein the first display comprises an internal display visible when said wireless communication device operates in said open configuration and concealed when said wireless communication device operates in said closed configuration, and wherein the second display comprises an external display visible when said wireless communication device operates in said closed configuration.

3. The wireless communication device of claim 1 wherein the first and second display areas are part of one display, wherein the first display area comprises the portion of the display visible when said wireless communication device operates in said open configuration, and wherein the second display area comprises the portion of the display visible when said wireless communication device operates in said closed configuration.

4. The wireless communication device of claim 1 wherein the audio output device comprises at least one of a speaker and an audio output port.

5. The wireless communication device of claim 1 wherein the audio-video processor is further configured to put the first display area in a sleep mode or power down the first display area when the wireless communication device operates in the closed configuration.

6. The wireless communication device of claim 1 further comprising a sensor configured to detect the current configuration of the wireless communication device.

7. A method of rendering audio-video signals on user interface elements of a wireless communication device, the method comprising:
outputting an audio component of the audio-video signals to an audio output device when the wireless communication device operates in an open configuration and in a closed configuration;
outputting a video component of the audio-video signal to a first display area when a current configuration of the wireless communication device comprises the open configuration;
and
outputting metadata associated with the audio-video signal to a second display area and discontinuing the video component output to the first display area when a current configuration of the wireless communication device comprise the closed configuration.

8. The method of claim 7 wherein the first and second display areas comprise separate first and second displays, wherein the first display comprises an internal display visible when said wireless communication device operates in said open configuration and concealed when said wireless communication device operates in said closed configuration, and wherein the second display comprises an external display visible when said wireless communication device operates in said closed configuration.

9. The method of claim 7 wherein the first and second display areas are part of one display, wherein the first display area comprises the portion of the display visible when said wireless communication device operates in said open configuration, and wherein the second display area comprises the portion of the display visible when said wireless communication device operates in said closed configuration.

10. The method of claim 7 wherein outputting the audio component comprises outputting the audio component to at least one of a speaker and an audio output port when the wireless communication device operates in the open configuration and the closed configuration.

11. The method of claim 7 further comprising putting the first display area in a sleep mode or powering down the first display area when the wireless communication device operates in the closed configuration.

12. The method of claim 7 further comprising detecting the current configuration of the wireless communication device.
